(19) United States
(12) Patent Application Publication
(10) Pub. No.: US 2005/0181651 A1
(43) Pub. Date: Aug. 18, 2005

(54) Board-connecting terminal

(75) Inventor: Kaoru Matsumura, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/059,415

(22) Filed: Feb. 17, 2005

(30) Foreign Application Priority Data
Feb. 17, 2004 (JP) 2004-039349

(51) Int. Cl. H01R 13/62

(52) U.S. Cl. 439/259

(57) ABSTRACT

Providing a board-connecting terminal capable to prevent damage to a circuit board, such as whitening and peeling, and to supply stable electrical contact corresponding to finished diameters of throughholes, the board-connecting terminal has an elastic contact to be connected electrically therewith. The elastic contact includes a pair of strip contacts at both sides of the elastic contact to leave a space to deform elastically in a direction of approach. A central part in a direction of widthwise of the each strip contact is formed thicker than an other part thereof, and both free ends continued to the central part are formed thinner than the central part so as to deform elastically along a circumference of an inner wall of the throughhole sectioned in such a direction being perpendicular to an axis of the throughhole.

The priority application Number Japan Patent Application 2004-039349 upon which this patent application is based is hereby incorporated by reference.

### BACKGROUND OF THE INVENTION

1. Field of the Invention

This invention relates to a board-connecting terminal, which is press-fitted into a throughhole of a circuit board, such as a printed circuit board and a bus bar, so as to connect electrically in the throughhole.

2. Description of the Related Art

Generally, to connect a circuit board and an electric component by a board-connecting terminal, a soldering operation is required after inserting a terminal into a throughhole. This operation has poor manufacturability and a possibility of a connecting failure caused by heating. Therefore, a connecting method having good manufacturability and high reliability of connection is required.

A board-connecting terminal called a press-fit terminal or a press-in terminal is used popularly as a terminal, which can connect electrically in the throughhole without soldering. The terminal has an elastic contact to be press-fitted into the throughhole. By elastically deforming the elastic contact, the terminal is connected electrically and prevented from falling out (held mechanically).

FIG. 5 shows one example of such solderless board-connecting terminal (reference patent 1). The board-connecting terminal is applied to a multiple-layer printed circuit board, which is made by laminating a printed circuit board for high-speed signal transmission 60 and a printed circuit board for low-speed signal transmission 63.

Press-fit terminals 51, 55 to be used as the board-connecting terminals are applied both to high-speed signal transmission and low-speed signal transmission. The press-fit terminals 51, 55 are made of any one of a copper alloy and an aluminum alloy, which have spring action, and formed into a rod shape by pressing. Elastic contacts 52, 56 to be press-fitted into the throughholes 61, 64 have respectively slit-shaped deflection spaces 54, 58 so that the elastic contacts 52, 56 can be deformed elastically to be close to each other. Top ends 53, 57 of the press-fit terminals 51, 55 are tapered narrower toward ends thereof so as to press-fit the press-fit terminals 51, 55 into the throughholes 61, 64 smoothly.

The reference patent 1 is Japan Patent Application No. 2003-283093.

### OBJECTS TO BE SOLVED

Usual board-connecting terminals, as shown in FIG. 5, have following problems. The throughholes 61, 64 of the printed circuit boards 60, 63 and a bus bar have dispersion of finished dimensions. Thereby, reliability of electrical connection between the throughholes 61, 64 and the terminals 51, 55 is deteriorated and holding forces of the terminals 51, 55 are reduced.

Various materials and shapes of the elastic contacts 52, 56 of the terminals 51, 55 have been discussed to strengthen spring forces of the elastic contacts 52, 56 for corresponding to the finished dimensions of the throughholes 61, 64. If thickness of the terminals 51, 55 are increased to enlarge a spring constant thereof, when the finished dimension of the throughholes 61, 64 is relatively small, contact forces between the terminals and the throughholes are increased so that the printed circuit boards 60, 63 may become damaged such as whitening and peeling to cause contact failure. Whitening herein means that an area of synthetic resign, which has a stress, such as a tensile stress and a bending stress, over an allowable stress thereof, is whitened.

The elastic contacts 52, 56 of the terminals 51, 55 project in a direction B shown with an arrow in FIG. 5 to widen the slit-shaped deflection spaces 54, 58 between the elastic contacts 52, 56. Contact stability between the terminals 51, 55 and throughholes 61, 64 in the direction B is increased by deformation of the elastic contacts 51, 55 in the direction B to approach each other. However, the contact stability therebetween in a direction perpendicular both to the direction B and an axis of the throughholes 61, 64 is relatively lower. Therefore, the terminal can move easily so that the reliability of electrical connection between the throughholes 61, 64 and the terminals 51, 55 is deteriorated.

### SUMMERY OF INVENTION

To overcome the above problems, an object of this invention is to provide a board-connecting terminal which can correspond to a finished dimension of a throughhole without damage such as whitening and peeling of a circuit board, and has stable electrical contact and mechanical holding force.

How to Attain the Object

In order to attain the object of the invention, a board-connecting terminal according to a scope of this invention has an elastic contact, which is press-fitted into a throughhole of a circuit board so as to be connected electrically with the throughhole. The elastic contact includes a pair of strip contacts, which can deform elastically in a direction of approach, at both sides of the elastic constant to leave a space of deformation. Each central part in a widthwise direction of the strip contacts is formed thicker than other part thereof. Both free ends continuous to the central part of the strip contact are formed thinner than the central part so as to be deformed elastically along an inner wall of the throughhole in a direction perpendicular to an axis of the throughhole.

According to the board-connecting terminal mentioned above, when the elastic contact is press-fitted into the throughhole, the pair of strip contacts is deformed elastically in a direction to be close to each other by inward force from an inner wall of the throughhole. Thereby, an outer surface of each strip contact touches electrically to the inner wall of the throughhole, and the board-connecting terminal is prevented from coming out from the throughhole by friction force between the surfaces contacting to each other. The central part in the widthwise direction of the each strip contact touches strongly to the inner wall of the throughhole by the elastic restoring force. Both free ends of the each strip contact also contact to the inner wall of the throughhole. Thus, each strip contact touches to a wide area along a circumference of the inner wall of the throughhole.

The board-connecting terminal according to a scope of the present invention is further characterized by that the outer surface of the free end of the each strip contact is formed into a curved surface curving inwardly.

According to the board-connecting terminal mentioned above, the free end of the each strip contact is prevented from interference with an opening edge of the throughhole, and is easily deformed elastically along the inner wall of the throughhole.

The board-connecting terminal according to a scope of the present invention is further specified by that the outer surface of the central part of the each strip contact is formed into a flat surface parallel to the axis of the throughhole.

According to the board-connecting terminal mentioned above, the outer surface of the central part of each strip contact does not touch to the inner wall of the throughhole. Therefore, the contact force between the throughhole concentrates on the free end of each strip contact, so that the free end is largely deformed inwardly about a fixed point of a foot side thereof.

The above and other objects and features of this invention will become more apparent from the following description taken in conjunction with the accompanying drawings.

### BRIEF DESCRIPTION OF THE DRAWINGS

FIG. 1 is a perspective view of an embodiment of a board-connecting terminal according to the present invention;

FIG. 2 is a front view of the board-connecting terminal shown in FIG. 1, and a cross-sectional printed circuit board;

FIG. 3 is a cross-sectional view taken along the line A-A in FIG. 2;

FIG. 4 is a cross-sectional view, showing an elastic contact of the board-connecting terminal press-fitted into a throughhole and deformed; and

FIG. 5 is a front view of an example of a conventional press-fit board-connecting terminal, and a cross-sectional conventional printed circuit board.

### DESCRIPTION OF THE PREFERRED EMBODIMENT

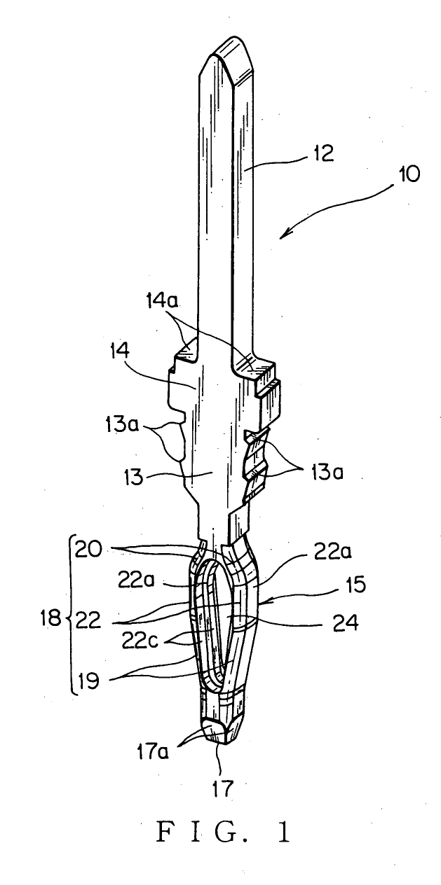

An embodiment of a board-connecting terminal according the present invention will be described with reference to FIGS. 1-4. FIGS. 1-4 show the board-connecting terminal according to the present invention.

A press-fit terminal 10, as a board-connecting terminal, is a solderless connecting terminal to be inserted into a throughhole 31 of a circuit board, such as a printed circuit board 30 or a bus bar (not shown), for connecting electrically the printed circuit board 30 and an electric component such as a board connector. The press-fit terminal 10 is made of any one selected from the group of copper alloys, such as brass, phosphorus bronze, beryllium bronze and the like, or an aluminum alloy, which are elastic deformable electrical conductive metals. The press-fit terminal 10 is formed into a thin long rod by punching an electric conductive plate and pressing it after punching.

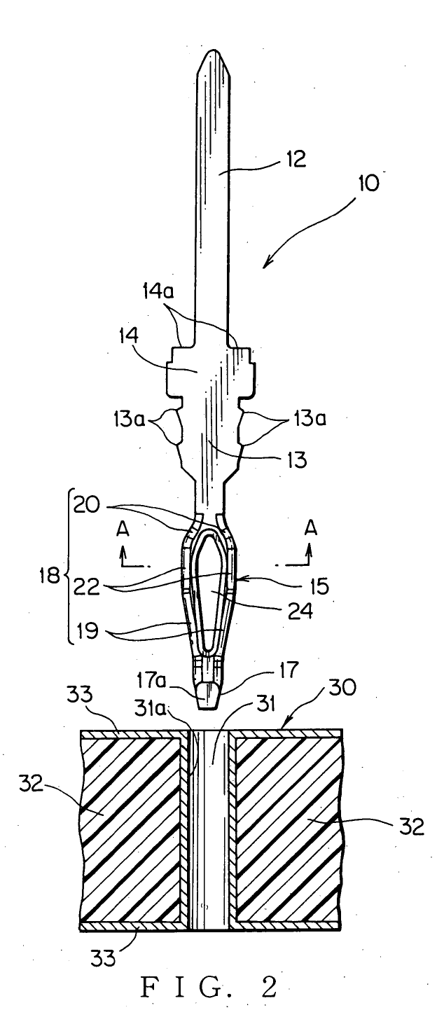

The printed circuit board 30 is used for supplying electric power to meters at an instrument panel of a vehicle, lighting equipment or generators, and for transmitting signals intensively. As a part of the printed circuit board 30, shown in FIG. 2, the printed circuit board 30 has a flat-plate shaped double-side printed circuit board, which is an insulation board 32, made of an organic material such as epoxy resin, formed with conductive patterns (not shown) on the both surfaces thereof.

The insulation board 32 has various epoxy resin board types, such as a paper-base epoxy board, a glass-cloth-base epoxy board, and a paper-and-glass-cloth composite epoxy board. Conductive metal foil, such as copper foil, of a 10 micron thickness is applied to a wiring conductor 33 forming the conductive patterns (not shown). In this embodiment, the printed circuit board 30, on which the wiring conductor 33 is printed, is used. The insulation board 32, on which narrow wiring conductors (not shown) are formed by insert molding or adhering, can be used. A conductive resin can be used for the wiring conductors.

The bus bar (not shown) is used at an electric connecting box such as a junction box mounted in an engine compartment or an interior of a vehicle. The bus bar (not shown) is a pure conductive material board structuring an inner circuit in a box body (not shown). Punching a board made of good conductive copper alloy or aluminum alloy according to the conductive pattern (not shown) forms the bus bar (not shown).

The throughhole 31 of the printed circuit board 30 is made to go through in a direction of thickness of the printed circuit board 30 by a small diameter carbide tap or laser. An inner wall 31a of the throughhole 31 is plated with conductive material (not shown) like a copper foil as same as the wiring conductor 33 on the printed circuit board 30. The throughhole 31 of the bus bar is formed by a press machine. Thereby, a pure metal surface is exposed in the throughhole 31.

The press-fit terminal 10 according to this embodiment can prevent damage of whitening and peeling of the printed circuit board 30, and can obtain stable electric contact according to the finished diameter of the throughhole 31. The press-fit terminal 10 is held in the throughhole 31 with stability and direction independence. An elastic contact 15 of the press-fit terminal 10 has a pair of strip contacts 18, 18, which can be deformed elastically in a direction to be close to each other, opposing at both sides of a slit-shaped deflection space 24 of the elastic contact 15. Each of the two central part 22a in a widthwise direction of the strip contacts 18 is formed thicker than an other part thereof. Free ends 22c continuous to the central part 22a of the each strip contacts 18 are formed thinner than the central parts 22a so as to be deformed elastically along an inner wall 31a of the throughhole 31 in a direction perpendicular to an axis of the throughhole 31.

Actions of main parts of the press-fit terminal 10 according to this embodiment will be described in detail hereafter. As shown in FIG. 1, the press-fit terminal 10 has the elastic contact 15 at one side of the press-fit terminal 10 in the direction of the axis of the throughhole 31, and an electric contact portion 12 at the other side thereof, and positioning portions 13, 14 at a central part thereof. An overall shape of the press-fit terminal 10 is formed into a rod.

The elastic contact 15 has a tapered portion 17 including a tapered surface 17a at a top thereof and the pair of strip contacts 18, 18 continuous to the tapered portion 17 and placed at the both sides of the slit-shaped deflection space 24. The elastic contact 15 is guided by the tapered portion 17 and press-fitted into the throughhole 31. The pair of strip contacts 18, 18 includes bottom slant portions 19 continuous to the tapered portion 17 and gradually projecting outwardly, straight portions 22 continuous to the bottom slant portions 19 and parallel to the direction of the axis, and top slant portions 20 continuous to the straight portions 22 and gradually shrinking inwardly. Since the straight portions 22 are provided between the bottom slant portions 19 and the top slant portions 20, contact area between the inner wall 31a of the throughhole 31 and the outer surface of the pair of strip contacts 18, 18 is made long in the direction of the axis. Thereby, contact resistance is reduced and reliability of contact is increased.

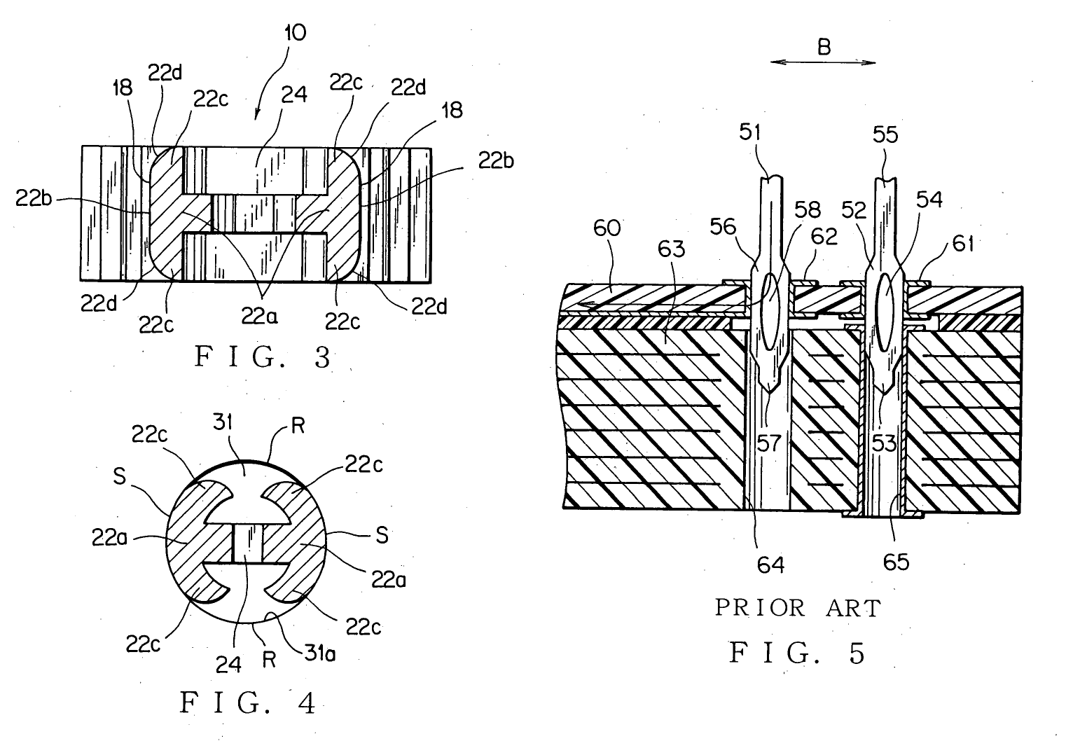

The straight portions 22 separated by the slit-shaped deflection space 24 are bilaterally symmetric in cross-section as shown in FIG. 3. Thereby, the pair of strip contacts 18, 18 can be deformed elastically to narrow the slit-shaped deflection space 24, that is, so as to close the slit-shaped deflection space 24.

Each strip contact 18, 18 is bilaterally symmetric in the widthwise direction thereof. The central parts 22a are formed thicker than the other parts and the free ends 22c continuous to the central parts 22a are thinner than the central parts 22a. Thereby, the elastic contact 15 has a large polar moment of inertia of area so that a bending stiffness against an external-force in the direction perpendicular to the axis on the press-fit terminal 10 is increased. The press-fit terminal 10 is prevented from breakage and bending, and press-fitted securely into the throughhole 31 of the printed circuit board 30.

The thick central parts 22a form a loop shape, and are deformed elastically as both-end-supported beams to narrow the slit-shaped deflection space 24 about a whole shape. The thick central parts 22a is not deformed. Oppositely, the thin free ends 22c are formed thinner than the central parts 22a and deformed elastically so as to follow along the inner wall 31a of the throughhole 31. Thickness of the free ends 22c can be determined freely according to material, shape and size. When the thickness of the free ends 22c are too thin, the free ends 22c are deformed plastically over an elastic limit, and lose spring action. Therefore, the thickness of the free ends 22c are usually selected to be approximately a half of the thickness of the central parts 22a.

An outer surface, touching to the inner wall 31a of the throughhole 31, of the free ends 22c is formed into curved surfaces 22d curving inwardly (FIG. 3). Thereby, when the elastic contact 15 is press-fitted into the throughhole 31, the free ends 22c are prevented from interfering with the opening edge of the throughhole 31. The elastic contact 15 is inserted smoothly into the throughhole without sticking. The outer surface of the free ends 22c preferably are preferably a curved surface having a smaller curvature radius than a radius of the throughhole 31.

The outer surface of the central parts 22a between the outer surfaces of the free ends 22c is formed into flat surfaces 22b parallel to the direction of the axis of the throughhole 31 (FIG. 3). When the elastic contact 15 is press-fitted into the throughhole 31, the free ends 22c abut strongly on the inner wall 31a of the throughhole 31. Thereby, the free ends 22c are easily deformed inwardly in the radial direction about a fixed point of a foot side thereof. Two free ends 22c, 22c at the both sides of each of the strip contacts 18 abut on the inner wall 31a of the throughhole 31, so that the elastic contact 15 is held on at least four free ends 22c, 22c, 22c, 22c by the throughhole 31. Contact areas S (FIG. 4) of the elastic contact 15 and the inner wall 31a of the throughhole 31 are formed wide along a circumference of the inner wall 31a sectioned perpendicular to the axis of the throughhole 31.

FIG. 4 shows contact condition of the inner wall 31a of the throughhole 31 and the pair of strip contacts 18, 18. The contact areas S, which are formed by touching whole outer surface of the strip contacts 18 to the inner wall 31a, are shown at right/left sides of the throughhole 31. Non-contact areas R are shown at top/bottom side of the throughhole 31. The contact areas S are formed wide along a circumference of the inner wall 31a sectioned perpendicular to the axis of the throughhole 31 so as to be almost the same as the non-contact areas R. Thereby, the contact areas of the inner wall 31a of the throughhole 31 and the pair of strip contacts 18, 18 are increased so that contact force is widely dispersed along the circumference of the inner wall 31a of the throughhole 31. Therefore, the printed circuit board 30 is prevented from damage such as whitening and peeling. Balance of contact of the elastic contact piece 15 becomes better, and direction dependence of bending stiffness of the press-fit terminal 10 is reduced. When the elastic contact piece 15 is press-fitted into the throughhole 31, the press-fit terminal 10 is prevented from breakage and bending. Thus, reliability of contact and manufacturability of press-fitting are improved.

The throughhole 31 shown in FIG. 4 has a real circular cross-section. Actually, the throughholes 31 are formed into an elliptical shape or a warped circular shape by manufacturing error. Some throughholes of the bus bar (not shown) have a rectangular shape. The press-fit terminal 10 according to this embodiment has thin free ends to be elastically deformed easily, so that, even if the throughhole 31 has a cross-section of the elliptical shape or the rectangular shape, the press-fit terminal 10 can be deformed corresponding to these shapes. Therefore, the press-fit terminal 10 maintains stable reliability of contact. When a diameter of the throughhole 31 is varied within tolerance, the press-fit terminal 10 can follow various diameters and maintains reliability of contact.

An electric contact portion 12 (FIGS. 1, 2) is inserted into a female connector housing of a board connector (not shown) and held therein. The electric contact portion 12 projects into a connecting space of the female connector (not shown) to connect with a mating male connector (not shown) for connecting the male electric contact portion 12 and a female terminal. The male electric contact portion 12 can be connected with a printed circuit board (not shown) stacked on the printed circuit board 30 shown in FIG. 2.

The positioning portion 13 (FIGS. 1, 2) positions the press-fit terminal 10 in a direction of press-fitting when the press-fit terminal 10 is press-fitted into the throughhole 31 of the printed circuit board 30. The positioning portion 14 (FIGS. 1, 2) positions the press-fit terminal 10 in a direction of press-fitting when the press-fit terminal 10 is press-fitted into the female connector housing of the board connector. The positioning portion 13 for a bottom-side board has a plurality of locks 13a locked with the opening edge of the throughhole 31 both for positioning and locking. The positioning portion 14 for a top-side connector has a stopper 14a at an edge surface thereof for limiting a length of the (male) electric contact portion 12 projecting into the connecting space of the female connector housing.

Action of the press-fit terminal 10 according to this embodiment will be described. As shown in FIG. 2, the press-fit terminal 10 is press-fitted into the throughhole 31 of the printed circuit board 30 from topside. The tapered portion 17 of the elastic contact 15 includes the tapered surface 17.a at a top thereof. Thereby, even if a center of the axis of the press-fit terminal 10 is slightly displaced from the center of the throughhole 31, the tapered portion 17 is inserted into the throughhole 31 without interference against the opening edge of the throughhole 31. Thereafter, when the bottom slant portions 19 of the elastic contact 15 are inserted into the throughhole 31, the bottom slant portions 19 abut on the opening edge of the throughhole 31, and are guided and elastically deformed to make the pair of strip contacts 18, 18 close to each other by the opening edge. When the press-fit terminal 10 is furthermore inserted deeply, the press-fit terminal 10 is deformed to make the straight portions 22 of the pair of strip contacts 18, 18 close to each other and inserted deeply into the throughhole 31. At this time, the thick central part 22a of the strip contact 18 pushes the inner wall 31a of the throughhole 31 by a strong elastic restoring force, and also free ends 22c push the inner wall 31a of the throughhole 31 by an elastic restoring force so as to make the outer surface of the each strip contact 18 contact at whole area or partially with the inner wall 31a of the throughhole 31.

As mentioned above, the elastic contact 15 having the pair of strip contacts 18, 18 touches to the inner wall 31a of the throughhole 31 at a wide contact area. Thereby, the contact force is dispersed along the circumference of the inner wall 31a of the throughhole 31 sectioned perpendicular to the axis of the throughhole 31. An area of a large contact force and an area of a small contact force are removed. The elastic contact 15 is prevented from falling out of the throughhole 31 and displacement in a specific direction. If the finished diameters of the throughholes 31 are varied, stable electric contact can be maintained, and the reliability of contact is much improved.

Having now fully described the invention, it will be apparent to one of ordinary skill in the art that many changes and modifications can be made thereto without departing from the spirit and scope of the invention as set forth herein.

1. A board-connecting terminal comprising an elastic contact, which is press-fitted into a throughhole of a circuit board so as to be connected electrically with the throughhole,
whereby said elastic contact comprises a pair of strip contacts, deformable elastically in a direction of approach, at both sides of the elastic contact to leave a space of deformation,
wherein said pair of strip contacts comprises:
central parts in a widthwise direction of the strip contacts to be formed thicker than an other part thereof; and
free ends continued to the central part of the strip contact to be formed thinner than the central part so as to be deformed elastically along an inner wall of the throughhole in such a direction as being perpendicular to an axis of the throughhole.

2. The board-connecting terminal according to claim 1, wherein an outer surface of the free ends of the strip contact are formed into a curved surface curving inwardly.

3. The board-connecting terminal according to claim 1 or 2, wherein an outer surface of the central part of the strip contact is formed into a flat surface parallel to the axis of the throughhole.
